(19) United States
(12) Patent Application Publication
(10) Pub. No.: US 2015/0012287 A1
(43) Pub. Date: Jan. 8, 2015

(54) SYSTEM FOR MANAGING CONFIDENTIAL INFORMATION RECORDS AND PROVIDING SECONDARY CONTENT ON A MOBILE COMPUTING DEVICE, AND METHODS OF USING THE SAME

(71) Applicant: Subdirect, LLC, Fresno, CA (US)

(72) Inventors: Kelly N. Vucovich, Fresno, CA (US); Brian C. Knowles, Montclair, NJ (US)

(21) Appl. No.: 14/320,281

(22) Filed: Jun. 30, 2014

Related U.S. Application Data
(60) Provisional application No. 61/842,012, filed on Jul. 2, 2013.

(51) Int. Cl. G06F 19/00; G06Q 30/02; G06F 21/60

(52) U.S. Cl. CPC G06F 19/363; G06F 21/60; G06Q 30/0267
USPC 705/2

(57) ABSTRACT

The present invention provides systems including at least one mobile computing device and methods of using the same for (1) in a secure first mode, collecting confidential information from a user and transmitting said information to a secured storage device and (2) in a second mode, providing the user with secondary content (such as entertainment, informational and/or educational content), where once the device transitions from the secure first mode to the second mode, all confidential information on the device is deleted. In some further embodiments, non-confidential data relating to the secondary content may be collected and transmitted to a storage device. The mobile computing system may have a software platform for laying on top of the native operating system of the mobile computing device. The present invention is designed to allow efficient collection of (i) secure, confidential data and (ii) data relating to the user's interaction with secondary content on the mobile computing device, where the two sets of data are sequestered from another.

### CROSS-REFERENCE TO RELATED APPLICATIONS

This application claims priority of U.S. Provisional Patent Application No. 61/842,012, filed Jul. 2, 2013, hereby incorporated by reference in its entirety.

### FIELD OF THE INVENTION

The present invention relates to methods and systems for securely collecting confidential user data in a secure first mode and providing entertainment and/or informational material in a second mode, while maintaining the confidentiality of the confidential user data. In some aspects, the second mode may further enable collection of user marketing and use data. In some aspects, the invention relates more particularly to methods and systems for collecting confidential information from patients via a mobile computing device in a first controlled software environment, transferring the confidential information to a secured storage device for access by a medical service provider, providing information and/or entertainment via the mobile computing device in a second controlled software environment, and collecting information about the user's access of information and/or entertainment in the second controlled software environment. In some other aspects, the invention can be used to administer secure educational examinations in the first software controlled environment and providing information and/or entertainment in the second software controlled environment.

### DISCUSSION OF THE BACKGROUND

There are many situations in which a consumers, patients, students, etc. may be required to provide confidential information to a service provider. For instance, people regularly must fill out forms providing confidential information (social security number, health information, financial information, etc.) to apply for a loan, receive medical care, apply for government services, and other common processes. Conventional processes typically require several paper-and-pen forms, resulting in large volumes of paper files and extensive manual data entry in order to digitize files and information. There is a need for new systems and methods to streamline and digitize these processes in order to make such processes more efficient and reduce costs.

Confidential communications between healthcare providers and patients is particularly critical to the provision of quality medical care. Typically, during a consultation, a physician and patient exchange a large amount of information concerning the patient's medical history, current diet, exercise, and other behaviors, present physical condition, family history of illness, and/or the patient's present symptoms or illnesses, if any are present. Consequently, large amounts of information must be communicated between the physician and the patient. As discussed with reference to aspects of the present invention, mobile computing devices may be an effective tool in the communication and recordation of information regarding the patient and his or her treatment.

Additionally, the American Recovery and Reinvestment Act of 2009 provides incentives for healthcare providers to adopt, develop, and meaningfully use electronic medical record systems. The federal government has offered incentive payments to physicians and medical providers to update their patient record systems to a digital format. In the future the physicians and other medical service providers that fail to convert their patient record systems into digital electronic records may be penalized by reductions in Medicare reimbursements. Thus, there is a current need for efficient and secured electronic medical record (EMR) systems.

Current attempts to provide a solution to the need for capturing digital health and medical records are not scalable, are too capital intensive, are narrowly tailored to particular medical practices, and/or are not designed for efficient and effective patient use. In some medical facilities, patient information kiosks have been implemented as a means for patients to enter medical information into an EMR system. However, patient information kiosks have several drawbacks, including their large footprint in the reception area of the medical provider, and the availability to serve only one patient at a time. Patient information kiosks are also quite expensive (and are generally cost prohibitive for smaller medical service providers), and, because of their size and immobility, the kiosks do not allow for flexibility of use, only offering patient interface in the initial administrative process in the reception area and not providing any support once the patient is admitted into the examination area. Thus, kiosks offer an inefficient solution for transitioning to EMR systems. Consequently, larger facilities with capital and technology resources are designing their own in-house approaches to the transition to EMR administration. However, this is by its very nature, not a standardized application that can be scaled to the industry as a whole.

Visitors, when arriving at a service provider, must also have to wait for their paperwork to be processed and/or for the service provider to be ready to receive them. Conventionally, magazines, television, and other entertainment or informational materials are provided in a waiting room to occupy the visitors waiting to be seen by the service provider. These conventional approaches suffer from several disadvantages. For example, no individual magazine is available to two visitors at the same time. Visitors may occasionally remove all or part of a magazine from the waiting room, making it inaccessible for use by other visitors. Print magazines also suffer the disadvantage of cluttering the waiting room, and may pose sanitary issues due to the fact that numerous visitors (which may have viral or bacterial infections) engage with the magazine thus contributing to the spread of illness. In addition, conventional approaches do not allow the service provider or advertising and marketing companies to evaluate the preferences of the visitors. If visitor evaluation can be provided, the information and/or entertainment may be tailored to visitors, either individually or as a whole. One benefit of having the ability to evaluate a visitors use of informational and/or entertainment materials is that a service provider can determine the interests of its visitors, and may tailor the delivered content to the visitors, either individually or as a whole.

Most magazines, video, music, and other multimedia content is now available in digital formats, and may be available through various internet based delivery mechanisms (e.g., downloadable content, streaming content, etc.). There are various devices with which users can engage with such content, including portable tablets, mobile telephones, etc. Conventional access to certain content is restricted to users that maintain a fee-based subscription and a fee-based service plan for wirelessly accessing such digital content. Many users' exposure to a wide variety of magazines and other publications is thus limited, and typically, locations such as waiting rooms of medical service providers provide publishers a low cost of exposing a great number of users to differing publications in the hope of converting such users to subscription members.

It is therefore desirable to provide improved systems and methods for service providers to collect confidential information to a visitor or client in a secured digital medium. It is also desirable to provide entertainment and informational content to visitors of service providers, in furtherance of analysis of visitors' interests and to provide an efficient forum for publishers to market their entertainment and/or informational goods.

### SUMMARY OF THE INVENTION

The present invention provides improved systems and methods for service providers to securely collect confidential information from visitors, clients, patients, students, etc., and provide entertainment and informational content to these individuals. In particular, the invention relates to systems and methods of using mobile computing devices to collect confidential information (e.g., EMR data from patients) within a software platform having a secure first mode, and providing entertainment and informational content to the user within the software platform in a second mode while the user waits to see a service provider (e.g., a medical professional). The system and methods may optionally be configured to gather data regarding the user's preferences for informational and entertainment content.

The software platform may run on top of the native operating system of the mobile computing device, and provide a secured and self-contained software environment to enable a user to enter confidential information without risk of disclosure to unintended third parties. The confidential information may be securely transmitted to a secured storage device (e.g., a server) for storing and organizing the confidential information. The software platform may also have a second mode that is operationally separate from the secure first mode that provides informational, educational, and/or entertainment content (secondary content) for the user. Thus, access to the confidential information entered by the user in the secure first mode may be restricted to the user and the service provider. The system may allow the collection of data related to the user's selections of, and engagement with, secondary content, allowing the content provider to tailor the content provided within the second mode to the users' preferences and to use the data for other analysis and marketing purposes.

One particular field of use, without limiting the scope of the invention, is for medical service providers. In use, a patient will be given a mobile computing device (e.g., a tablet computer) that displays a navigable set of fillable forms that include requests for confidential information. Once the patient or user indicates that he or she has completed filling the forms (e.g., by selecting a “submit” function on the mobile computing device), the information in the forms will be electronically transmitted to an separate secured storage device (e.g., a server) controlled or accessible only by the authorized staff of the medical service provider. In some examples, the secured storage device may be located in a physical network on the service provider's facility. In some other examples, the secured storage device may be located in a remote network accessible by the service provider. The confidential information in the forms may also be optionally encrypted before being stored on, or transmitted to, the secured storage device. In some implementations, the form data (i.e., name, DOB, etc. fields) can be transmitted in a structured format (i.e., XML, CSV, etc.) to a database stored in the secured storage device. In other implementations, the form can be converted and transmitted as an encrypted document (i.e., a portable document format document, etc.). In some implementations, the form data can be emailed or otherwise transmitted in encrypted format directly to the provider and/or the patient.

The individual forms to be provided to the patient or user may vary depending, among other things, on the particular medical service provider that the patient visits. Different medical service providers (e.g., emergency rooms, orthopedic surgery facilities, family practices, etc.) may require different information collected from the patient, and therefore different forms. Additionally, each visit to a given medical service provider may require different forms (e.g., new patient forms, existing patient forms, updated insurance information forms, etc.). The mobile computing device can be preloaded with a plurality of generic forms. In addition, the medical office can create its own custom forms.

Depending on the patient-doctor encounter, the medical office will create a unique combination or collection of forms that the patient must fill out, thereby establishing a “work flow” path for the particular medical service provider and/or visit. For example, and without limitation, a work flow path for a new patient of an orthopedic medical office may include the following types of forms: patient contact; insurance and billing information; patient health history; reason for being seen; office policy; and privacy policy. In other examples, a work flow path for the same patient on a later date may include the following types of forms: confirmation of contact, insurance, and billing information; and reason for being seen.

Loading the particular forms on the mobile computing device may be done by the medical service provider's staff by loading the forms onto the mobile computing device prior to providing the mobile computing device to the patient. In some implementations, the medical service provider may manually enter various forms selected by the medical staff (e.g., particular work flow packages) onto the mobile computing device in the secure first mode, allowing the process to be easily tailored to a particular service provider, a particular patient, and/or a particular visit. For example, and without limitation, the forms can be loaded on the mobile computing device by connecting the mobile computing device to a computer having a plurality of forms to choose from. In some implementations, the medical staff may load a particular work flow package into the secured storage device, which may the same or a different memory element than the secured storage device to which the confidential data is transmitted. Upon handing the mobile computing device to the customer, the medical staff may provide the patient with a unique identification number such that the mobile computing device will retrieve the assigned work flow package from the secured storage device onto the mobile computing device when the patient signs into the mobile computing device using this unique identification number. In some implementations the unique identification number may be correlated to the patient's file. In some implementations however the unique identification number may correspond to a work flow set. For example, and without limitation, each work flow identification number may correspond to a single collection of forms to be completed by the patient (e.g., identification number “1” may correspond to a collection of forms for a new patient of Dr. Jones; identification number “2” may correspond to a collection of forms for a new patient of Dr. Smith; and identification number “3” may correspond to a collection of forms for a returning patient of Dr. Jones). The flexibility of the system to switch between different forms and work flows of present invention facilitates various work flows related to any particular area of medical services. For example, the systems and methods of the present invention may be instituted in a hospital offering a broad array of medical services by simply selecting a different set or package of forms for the patient in the secure first mode, without the need to tailor the software framework on the mobile computing devices or of the system generally.

Once the patient has completed filling out the forms provided to him or her in the secure first mode, a final page or screen may be presented to the patient in the secure first mode that includes a submission function (e.g., a “button”). When the submission function is activated (e.g., by touching a touchscreen of the mobile computing device in the area over the button), the forms may be submitted to the secured storage device (e.g., in a structured format to a database or by transmitting a portable document to the medical service provider). Additionally, when the submission function is activated, the patient may be locked out of the secure first mode, thereby preventing anyone, including the patient and other third parties from accessing on the mobile computing device the confidential information that was entered into the forms by the patient. All data entered by the patient into the forms in the secure first mode may also be deleted from the mobile computing device once the patient initiates the submission function, ensuring that no confidential information remains on, or may be obtained from, the mobile computing device. The secure first mode of the mobile computing device may only be reactivated by an authorized member of the medical service provider's staff.

After the patient completes the forms and is locked out of the secure first mode, the mobile computing device may be transitioned to, or placed in, a second mode. In the second mode, the user can access various entertainment services, including electronic periodicals, e-books, an internet browser, games, chat rooms, forums, etc. These services are offered within the specialized software platform in the second mode. The software environment of the second mode may be controlled and self-contained, offering only content and services that is predetermined by the operator of the software platform (e.g., the medical service provider, or the system manager hired by the medical service provider). For example, and without limitation, one medical service provider may enable access to a first set of periodicals and an internet browser, while another medical service provider may enable access to a second set of periodicals, a medical dictionary, and games. Patients or users may be prevented from exiting the software platform or use any applications or software in the native operating system of the mobile computing device.

In the second mode, the mobile computing device software may track the patient's entertainment and information choices (e.g., which magazines the patient accesses, which websites the patient visits, what informational content the patient accesses, etc.). This information may be collected and may also be saved on the mobile computing device or a content server that may the same or different than the secured storage device. The data related to the patients' use of the mobile computing device may be compiled by the medical service provider or a system manager to determine which content offered in the second mode is popular and which is unpopular and should be removed. Additionally, the patient may be asked to submit an email address or other personally identifying information to allow the software on the mobile computing device to track an individual patient's use, thereby allowing the system manager to tailor content and/or advertisements to the individual patient. In some implementations, the medical service provider may assign a unique identification number to each patient for these purposes. The medical service provider or an outside content manager may make changes to the multimedia content offered in the second mode easily through remote or direct access to the content server. The specific multimedia offered in the second mode can be easily changed. The user preference data may also have economic value to outside advertising firms and other entities, such as publishers, that are interested in using targeting marketing in the offices of medical service providers, or other kinds of businesses and entities that may be potential users of the presently disclosed systems and methods.

In some embodiments, in addition to the secure first mode for the collection of confidential patient information and the second mode, the system may have a secure third mode for use of the medical staff to review and update the patient's medical record. In some instances, once the patient is admitted to the examination room, the medical staff may take the mobile computing device from the patient and access the secure third mode by password or other secure access means, and thereby accessing the patient's medical records on a memory device, which may the same or different than the secured storage device to which the completed form data is transmitted. The patient's recently entered confidential information may be accessible to the authorized medical staff to allow efficient access to the patient's EMRs. The authorized medical staff may also enter new medical information (e.g., diagnoses, vital statistics, notes, prescriptions, etc.) into the secure third mode to be saved on the secured storage device. The authorized medical staff may also retrieve new forms for the patient to complete (e.g., consent to receive treatment, etc.). Upon completion of the doctor-patient encounter, the authorized medical staff may activate an exit command, at which point the information entered by the medical staff is securely transmitted to secured storage device and is erased from the mobile computing device.

The present invention provides methods and systems which may assist in complying with the Health Insurance Portability and Accountability Act of 1996 (HIPAA), incorporated herein by reference, including but not limited those sections pertaining to digitizing and streamlining the collection of personal, confidential information from the patient.

The present invention also provides methods and systems which may assist in complying with the American Recovery and Reinvestment Act of 2009 (ARRA), the Patient Protection and Affordable Care Act (PPACA or ACA), and the Health Care and Education Reconciliation Act of 2010 (HCERA), each of which are incorporated herein by reference, including but not limited to those sections pertaining to digitizing medical records.

The present invention further provides standardization and automation of the patient administrative process, allowing medical forms to be organized into a library and specific work flows that may be easily and efficiently selected for the patient by the medical service staff.

In addition, systems in accordance with some embodiments of the invention may be remotely controlled and updated by an associated system manager. For example, all of the mobile computing devices may be updated remotely with no time is wasted by having a “technician” needed to come out and physically service the device.

The invention also provides an efficient means of delivering entertainment and informational content to patients or users of the system as they wait for their appointment in a waiting area. Patients or users may be provided with entertainment and/or informational content without the limitations and clutter of print magazines or a single video offering.

Systems in accordance with some embodiments of the invention provide a means for the system manager to track patients' selections of entertainment and/or informational content in the second mode in order to collect analytical data about the types of content (e.g., particular magazines, videos, articles, games, websites, etc.) that are popular among the users. This information may be used to provide preferred content to the users, and to provide marketing data regarding the preferred content to outside marketing firms.

The present invention addresses the above-discussed concerns by providing a low-cost, flexible, and scalable EMR system having a substantially small physical footprint that collects the patient's confidential information in a secure software interface environment and which stores the information in a secured storage device having a database of EMR accessible only to authorized medical professionals and associates. Additionally, the present invention provides patients with a selection of informational and entertainment content (secondary content) options to view once they are done inputting patient information. The secondary content may be provided to the patient in a second mode or environment that is sequestered from the EMR secure first mode, allowing a provider of the secondary content to track the patient's secondary content preferences for market research purposes.

It is to be appreciated that the system and methods of the present invention are also applicable to other service providers, such as financial institutions, where the customer may fill out a loan application form in the secure first mode, submit the loan application to a secured storage device, and then view entertainment and informational content in the second mode while waiting to see a loan officer. Additionally, an educational institution may use a mobile computing device to administer exams to students, wherein the student enters exam answers on an exam form in the secure first mode, submits his test form to a secured storage device, and then is able to view additional educational materials in the second mode. The systems and methods of the present invention are further applicable to other processes and transactions that require the submission of confidential information to a service provider.

Additional objects of the invention will be apparent from the detailed descriptions and the claims herein.

### BRIEF DESCRIPTION OF THE DRAWINGS

FIG. 1 is an outline of a system for collecting confidential information and providing secondary entertainment and/or informational content on a mobile computing device to a user in accordance with some embodiments of the present invention.

FIG. 2 is a flow diagram illustrating process steps of the secure first mode and the second mode in accordance with some embodiments of the present invention.

FIG. 3 is a flow diagram illustrating process steps of the secure third mode in accordance with some embodiments of the present invention.

FIG. 4 is an example screen shot of a secure first mode from an exemplary software environment for a mobile computing device in accordance with some embodiments of the present invention.

FIG. 5 is an example screen shot of a secure first mode from an exemplary software environment for a mobile computing device in accordance with some embodiments of the present invention.

FIG. 6 is an example screen shot of a secure first mode from an exemplary software environment for a mobile computing device in accordance with some embodiments of the present invention.

FIGS. 7a and 7b are an example screen shot of a secure first mode from an exemplary software environment for a mobile computing device in accordance with some embodiments of the present invention.

FIG. 8 is an example screen shot of a secure first mode from an exemplary software environment for a mobile computing device in accordance with some embodiments of the present invention.

FIG. 9 is an example screen shot of a second mode from an exemplary software environment for a mobile computing device in accordance with some embodiments of the present invention.

FIG. 10 is an example screen shot of a second mode from an exemplary software environment for a mobile computing device in accordance with some embodiments of the present invention.

FIG. 11 is an example screen shot of a second mode from an exemplary software environment for a mobile computing device in accordance with some embodiments of the present invention.

FIG. 12 is an example screen shot of a second mode from an exemplary software environment for a mobile computing device in accordance with some embodiments of the present invention.

FIG. 13 is an example screen shot of a second mode from an exemplary software environment for a mobile computing device in accordance with some embodiments of the present invention.

FIG. 14 is an example screen shot of a second mode from an exemplary software environment for a mobile computing device in accordance with some embodiments of the present invention.

### DETAILED DESCRIPTION OF EXEMPLARY EMBODIMENTS

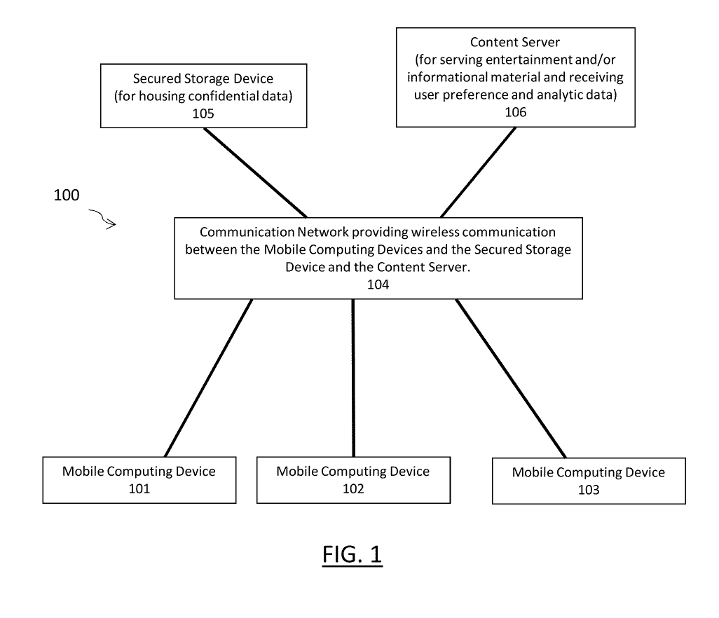

Referring to the drawings wherein like reference characters designate like or corresponding parts throughout the several views, and referring particularly to the illustrated embodiment of FIGS. 1-3, it is seen that the system of the present invention may include a plurality of mobile computing devices (e.g., a tablet PC, a smart phone, a PDA, etc.), each having a specializing software platform installed thereon, the platform having a secure first mode and a second mode. The system may also include a secured storage device for storing and providing confidential personal information (e.g., medical records) and a content server for delivering entertainment and/or informational material and/or receiving data regarding user data (e.g., selections of the multimedia content by users of the mobile computing devices).

As shown in FIG. 1, the system of the present invention may include a number of elements interconnected in an information management system 100 having a network 104 connecting at least one secured storage device 105 used in connection with the secure first mode, at least one content server 106 used in connection with the second mode, and one or more mobile computing devices 101, 102, and 103 each having a specialized software platform installed thereon. These elements are configured to allow the secure input of confidential information into the one or more mobile computing devices 101, 102, and 103, the secure delivery of the confidential information to the at least one secured storage device 105, and the access of multimedia content on the mobile computing device after the confidential information is transmitted. In some examples, the network may be a private wireless network, such as an enterprise intranet system having wireless access. In some examples, the information management system 100 may include plurality of secured storage devices 105. For instance, a hospital may have a number of secured storage devices for storing and organizing EMRs. The information management system 100 may include additional hardware (e.g., PCs with access to the secure and secondary server(s)), internet and other outside network connections, software (e.g., control logic), etc. to facilitate the operation of the information management system 100.

The at least one secured storage device 105 may be a conventional computer server system having hardware and software configured to store confidential user information in a secured, and optionally encrypted format, to prevent the disclosure of such information to unauthorized persons. The software installed on the server may be configured to organize the user data in a database that assigns an identification number to each user and categorizes different types of data into separate fields, allowing the user's confidential information to be retrieved easily by authorized personnel. The secured storage device 105 may be accessed by authorized personnel only.

The at least one content server 106 may be configured to provide entertainment and/or informational content to the user via the mobile computing device (e.g., device 101, 102, 103) in a second mode (e.g., the data collection mode of the mobile computing device). Alternatively, the content may be stored permanently or temporarily on the mobile computing devices 101, 102, and 103, or both the at least one content server 106 and the mobile computing devices 101, 102, and 103 may store content thereon. The content server 106 may also store user preference data collected by the software platform running on the mobile computing device. Data regarding the user's selections of particular content, and how such user interacts with such content, may be collected by the specialized software platform running on the mobile computing devices 101, 102, and 103 and then transmitted to the content server 106 and stored thereon for use in marketing or other purposes.

The one or more mobile computing devices 101, 102, and 103 may be any kind of device that is able to wirelessly connect to a network and exchange data through the network with a server, such as a tablet PC, a PDA, a laptop, a netbook, etc. The specialized software of the present system may be loaded onto the mobile computing devices as a software platform that operates on top of the native operating system of the mobile computing device. In some examples, the mobile computing device can be a smartphone or a tablet PC and the specialized software can be an application for use on top of the native operating system. In some examples, the specialized software in accordance with some embodiments of the present invention may prevent access by the user to the native operating system, thus disabling native features available to a commercially available device (such as preventing access to settings, or adding or deleting applications).

The software platform may include two or more mutually exclusive modes that have separate environments, e.g., a secure first mode and a second mode (i.e., “entertainment” mode). The secure first mode may be configured to allow the user to input confidential information (e.g., personal information, medical information, financial information, etc.) in a secure format (e.g., having limited privileges, allowing only data exchange between the mobile computing device and a secured storage device, such as secured storage device 105). The secure first mode may have a submission function that can be activated by the user once the user is finished entering information in the secure first mode. The submission function can (1) transmit the information entered by the user to the secured storage device, (2) lock the user out of, and prevent reentry into, the secure first mode, thereby securing the user's information on the server, and (3) delete the user's confidential information from the mobile computing device. In some implementations, only authorized personnel can activate the mobile computing device to re-enter the secure first mode once the submission function has been activated by the user.

The second mode of the software platform is initiated and displayed on the mobile computing device after the submission function is activated in the secure first mode. The second mode is separate from the secure first mode, and the user is prevented from accessing any of the information entered in the secure first mode while the mobile computing device is operating in the second mode. Thus, the software platform effectively sequesters the information entered by on the mobile computing device in the secure first mode on the secured storage device 105. The second mode may be configured to present various entertainment and/or informational content choices to the user. The content may be delivered, in real time, to the mobile computing device(s) 101, 102, 103 from the content server 106, and/or may be delivered for permanent or temporary storage on the mobile computing device(s). The software platform may also be configured to collect data regarding the user's selections and use of entertainment and/or informational content and transmit the data to one or more content server(s) 106 for use in marketing analysis, as discussed above. In some implementations, the use data may be transmitted directly to publishers, data clearinghouses, or marketing companies via connection to communication network 104 or content server 106.

The software platform may have optionally have a secure third mode to allow authorized personnel access to confidential information stored on the secured storage device 105. For instance, in the context of a medical service provider, the authorized medical staff (e.g., doctors, nurse practitioners, etc.) may be able access a patient's confidential medical information, charts, or records by logging into or receiving data from secured storage device 105 on the mobile computing device using an access code.

The information management system 100 may have an access scheme designed to maintain a high level of security for the secure portions of the network (e.g., the at least one secured storage device). The secure portions of the information management system 100 may be accessible through an authorization process that includes entry of one or more of the following into a user interface (e.g., a mobile computing device or PC connected to the information management system): a key code, an encryption key, a personal password, a key card, a biometric scan, and other authentication mechanisms that limit access to the information management system to only authorized personnel. In some examples the security of the secured storage device 105 may be configured to comply with HIPAA standards, allowing use of the information management system 100 by medical service providers. The secured storage device(s) 105 may store patient or user information in a secure database, optionally in encrypted form. Individual patient or user information may also be organized according to a unique identification number.

The present invention also relates to methods or processes of using the system described herein. The method generally includes loading a particular set of fillable forms (e.g., a work flow) on a mobile computing device, user entry of confidential information into forms in a secure software environment (e.g., a secure first mode), transfer of the confidential information to a secured storage device and deletion of the confidential information from the mobile computing device, locking the user out of the secure first mode once the user completes the forms in the secure first mode, and initiation of an second mode on the mobile computing device in which the user can select from various entertainment, educational, and/or informational multimedia offerings. In some optional embodiments, the method can further include, in the second mode, collection of user preference data regarding the user's selections from the entertainment and/or informational offerings, and saving the user preference data on a second server. The present methods may further include the steps of entering a secure third mode on the mobile computing device by authorized personnel to access and/or enter confidential information related to the user from the secured storage device.

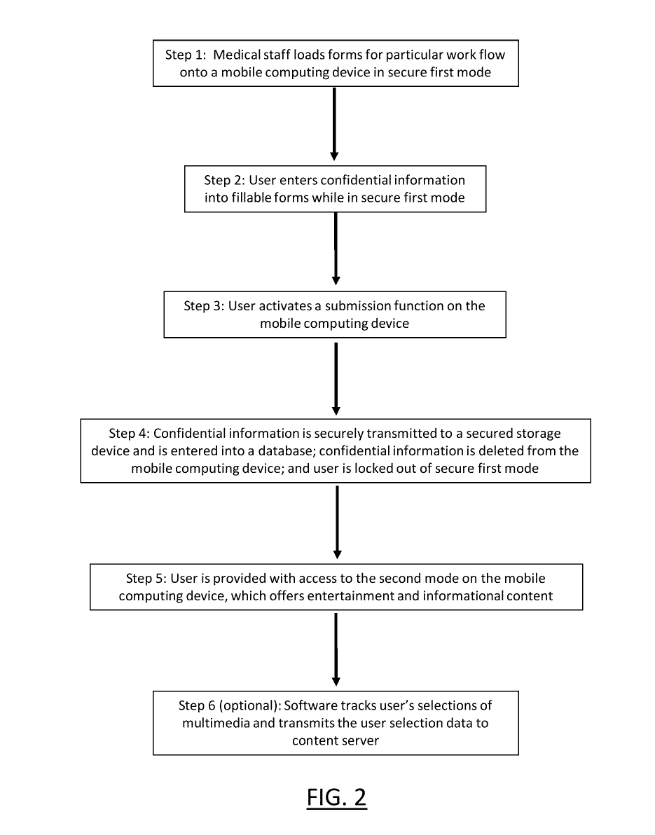

FIG. 2 provides a general flow diagram of one embodiment of the methods of the present invention in the context of a medical service provider. As shown in Step 1, an authorized medical staff member may preload or preselect forms on a mobile computing device for a patient. Depending on the patient-doctor encounter, the medical office may create a unique combination of forms that the patient must fill out, thereby establishing a work flow path for the particular medical service provider and/or visit. Thus, various form packages may be provided via a common mobile computing device in software platform and in the secure first mode, depending on the particular type of medical service provider. Additionally, a library of forms and form packages may be saved on the secured storage device, allowing the medical service provider to select particular forms or form packages from the library and loading them onto the mobile computing device in the secure first mode. In some implementations, the individual forms, collection of forms, and work flow will be individually loaded by the service provider before the patient is given the mobile computing device. For example, the medical service provider can physically or logically connect the mobile computing device to a computer workstation. In some implementations, the mobile computing devices can be preloaded with a suite of available forms, and the medical service provider can use the mobile computing device to select which forms that a particular user is to complete. In some other implementations, the mobile computing device can be configured to retrieve the form(s) and work flow from a storage location (for example, and without limitation, the secured storage device), and the medical service provider can configure the storage location to deliver a particular set of forms to a given mobile computing device. In some other implementations, a plurality of combinations of forms and work flow can each be assigned a unique number, and the medical service provider and/or the user can enter the number on the mobile computing device. In other implementations, each user can have a unique number (such as social security number, patient identification number, etc.) which they can input on an initial page of the mobile computing device, which can then retrieve pre-selected forms from the storage location.

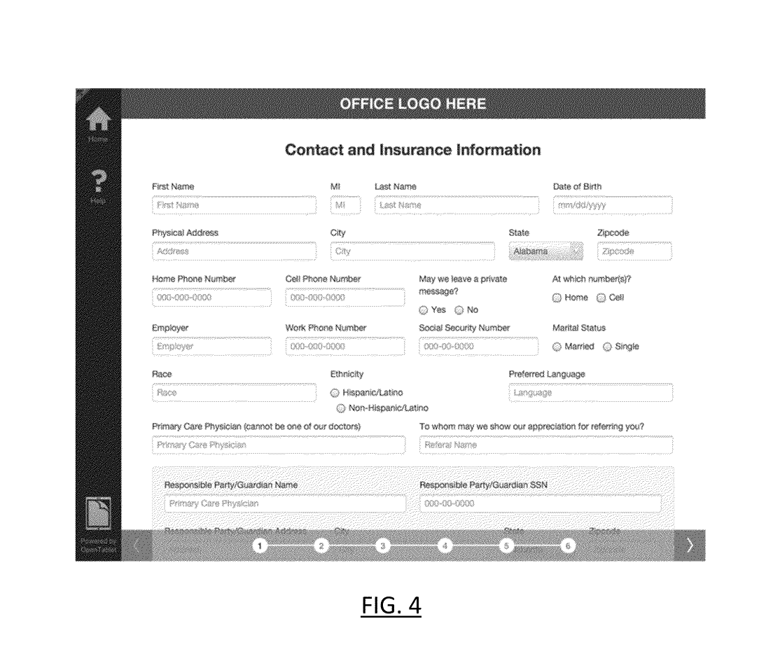

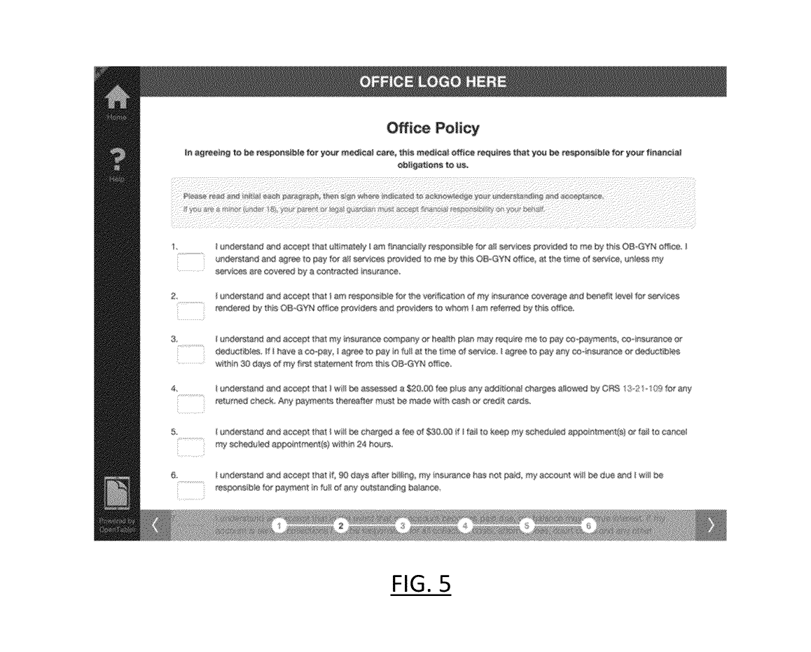

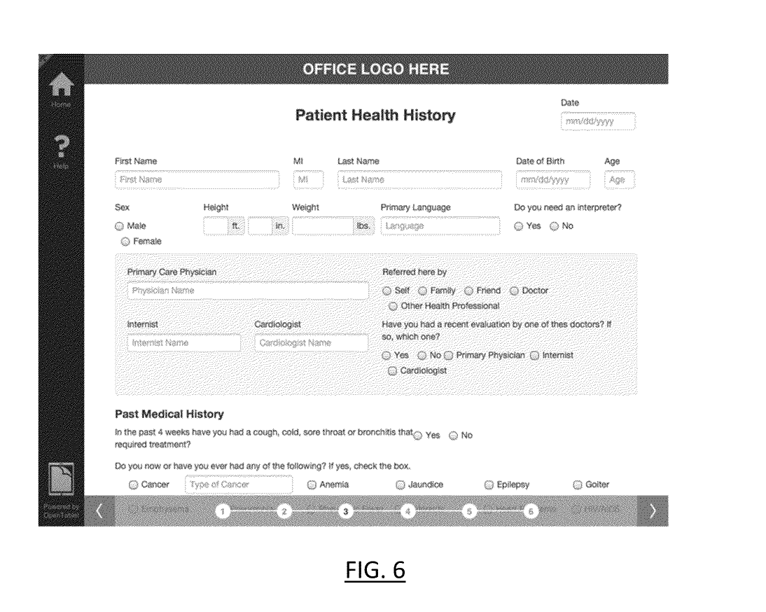

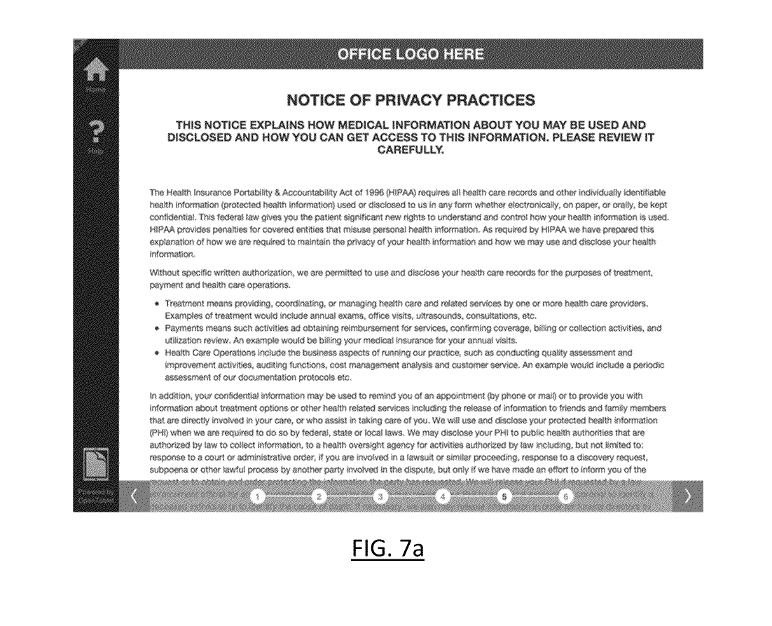

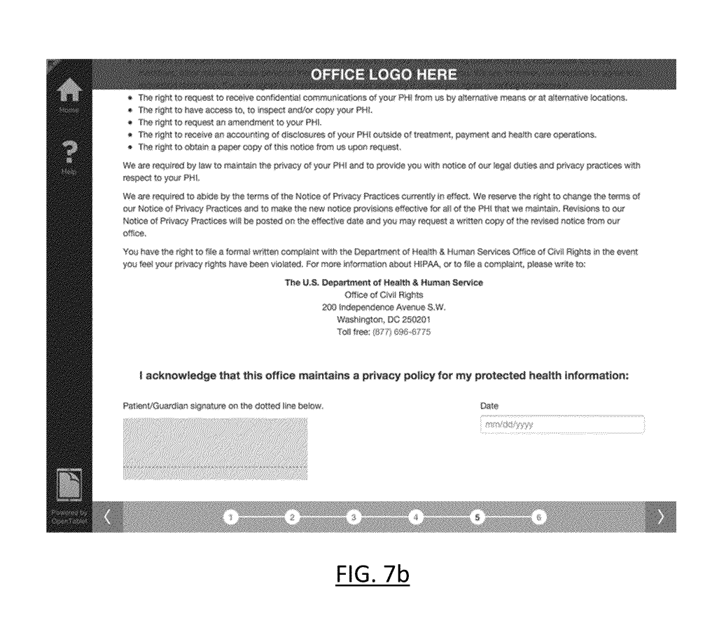

The patient may then enter confidential information into the selected forms in step 2. FIGS. 4-7b provide screen shots of example forms that may be similar to the forms used in Step 1. The forms filled out during this process may include requests for personal identification, contact information, and insurance or billing information (see, e.g., FIG. 4), office policy disclosures (see, e.g., FIG. 5), requests for a patient health history, including information related to the general health of the patient and/or specific medical conditions (see, e.g., FIG. 6), privacy notices (see, e.g., FIG. 7), and other forms that are appropriate to the particular patient or the particular purpose of the visit. Various other forms that may require the submission of confidential information may also be included in the secure first mode, such as a request for a photograph of the patient for identification purposes, requests to scan a medical insurance card, or a request for electronic payment information (i.e., credit card information, etc.).

The forms can request information to be provided in numerous manners, including but not limited to fill boxes (see, e.g., “First Name” on the form of FIG. 4), mutually exclusive radio buttons (see, e.g., “Sex” on the form of FIG. 6), and multi-selection radio buttons (see, e.g., “Past Medical History” on the form of FIG. 6). The forms can also provide areas where a user can digitally sign their name using a finger or stylus (see, e.g., signature block on the form of FIG. 7B).

In some implementations, each entry field in a particular form may be designated “required” or “optional”. If the field is designated as “required”, meaning that the form cannot be completed and submitted to the secured memory device without an entry in the field, the field may display text such as “required”, an asterisk (i.e., “*”), or may be displayed in a different color (i.e., red). In some implementations, each form in the work process must be completed before a user can complete another form. In other implementations, the user can move back and forth between forms.

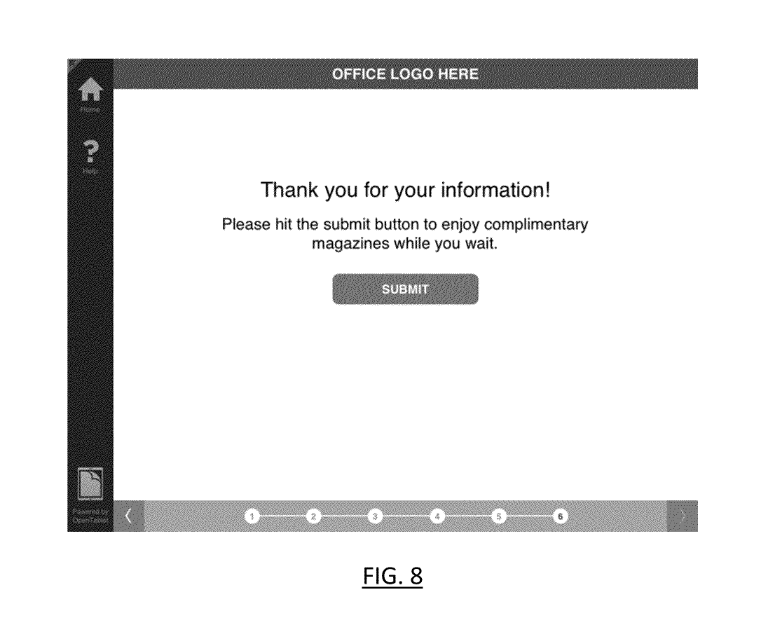

As shown in Step 3 of FIG. 2, once the patient has completed the selected forms, a final page or screen will be presented to the patient in the secure first mode that includes a submission function (e.g., a virtual “button”). FIG. 8 shows a screen shot of an example page that will be presented to the patient at the completion of the confidential forms. Prior to submission, the software may be configured to check the entry fields of the various forms and ensure completion. In some embodiments, a single check (or validation) can be performed after all of the forms are filled in by the user. In some other embodiments, a check can be performed when the user has filled in the requested field entries for each form, and the software may prevent the user from moving to the next form if not all required field entries have been completed. In some other embodiments, checking or validation can occur both on a per-form basis and when all of the forms have been completed. An optional “review” page can be included prior to the user activating the “submission function” where the user can review all pertinent form data. Each form, or each field entry in a particular form, may also include a “help” feature describing the solicited information. For example, and without limitation, the form in FIG. 6 may include a help feature associated with the radio button “Anemia” which describes clinical diagnoses of anemic medical conditions.

When the submission function is activated (e.g., by touching a touchscreen of the mobile computing device over the “submit” button), the forms may be submitted to the secured storage device in a structured format (e.g., Comma Separated Variable table, Extensible Markup Language file, etc.) to a database, in an encrypted portable document format, or other format. The final page or screen may also have an admonishment to the patient to review the information he or she has submitted, and/or a warning that the patient will not be allowed back into the secure first mode after submitting the forms. In some optional embodiments, the user can input his or her email address, and the system can provide, via email, a duplicate copy of the form to the user.

As shown in Step 4 of FIG. 2, when the submission function is activated, the patient becomes locked out of the secure first mode, preventing anyone, including the patient from accessing the confidential information that was previously entered into the forms by the patient. All data entered by the patient into the forms in the secure first mode is also deleted from the mobile computing device once the patient initiates the submission function, ensuring that no confidential information may be obtained from the mobile computing device. The secure first mode can only be reactivated by an authorized member of the medical service provider's staff.

As shown in Step 5 of FIG. 2, after the patient completes the forms and is locked out of the secure first mode, the mobile computing device is placed in a second mode (e.g., an “entertainment” or “informational” mode). The second mode may offer various entertainment, educational, and/or informational choices within the specialized software platform. The software environment of the second mode is self-contained and controlled, offering only content that is predetermined by the manager of the software platform (e.g., the medical service provider, or an information system manager hired by the medical service provider). In the second mode, the user may be provided access to various entertainment services, including but not limited to: 1) Digital magazines, with the option of emailing yourself the article/issue if the patient is not done reading by the time they are called by the doctor; 2) a “store” section featuring product and services catalogs, where patients can peruse publications or items to purchase; 3) a “community” section where the medical office can feature links to social media sites, support sites, frequently asked questions, events or meetings in the area, forums, chat rooms, etc.; 4) A “news” section where the medical office can feature relevant articles and promote new services; 5) A “educational” section where a medical office can feature articles and information pertaining to the medical discipline of the medical service provider (for example, a hematologist could provide articles and information pertaining to common blood diseases, the vascular system, etc.); 6) Internet browser; 7) Games; and/or 8) Generally any other content which the medical service provider chooses to make available to patients.

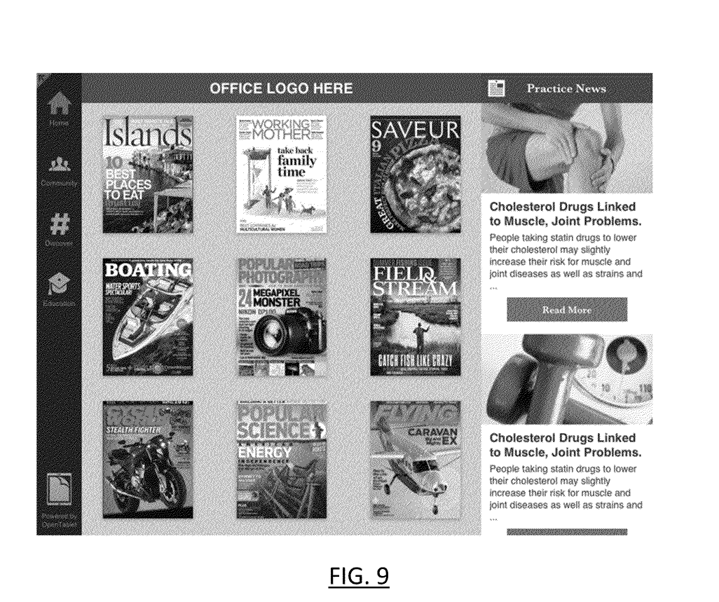

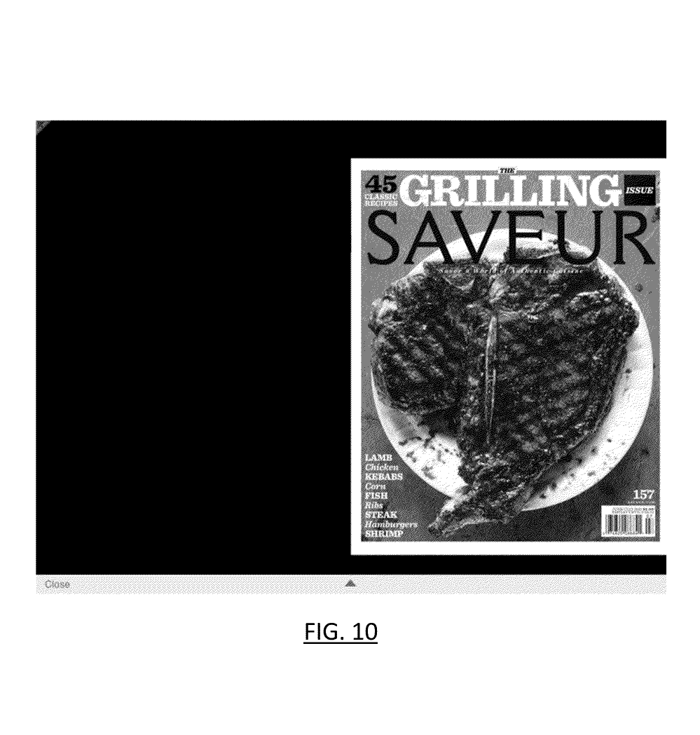

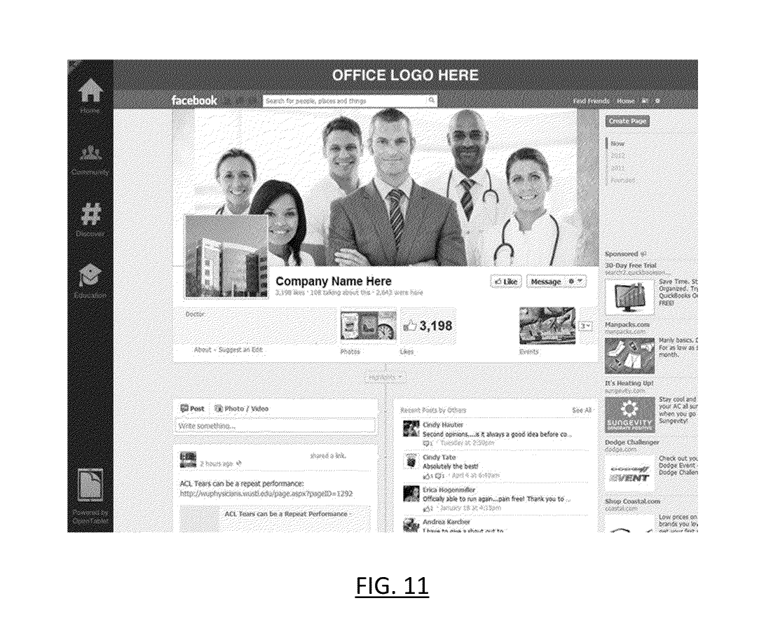

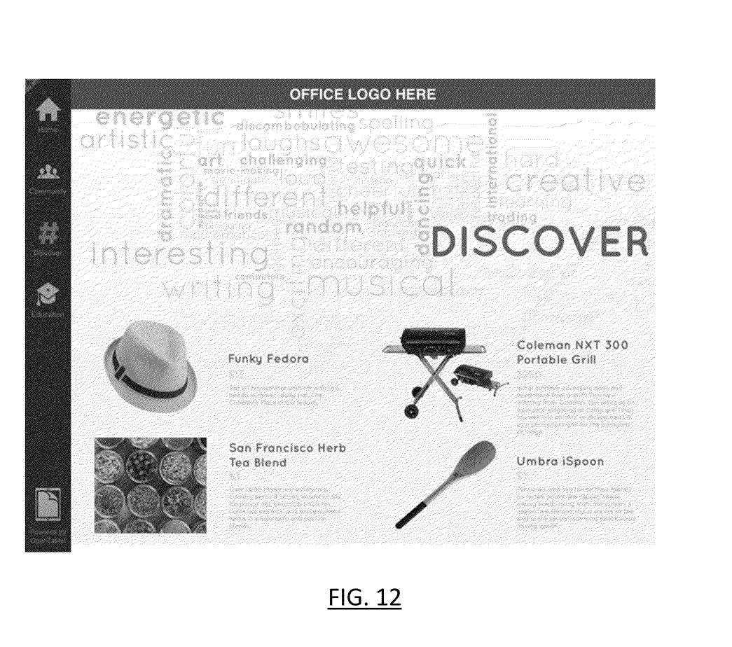

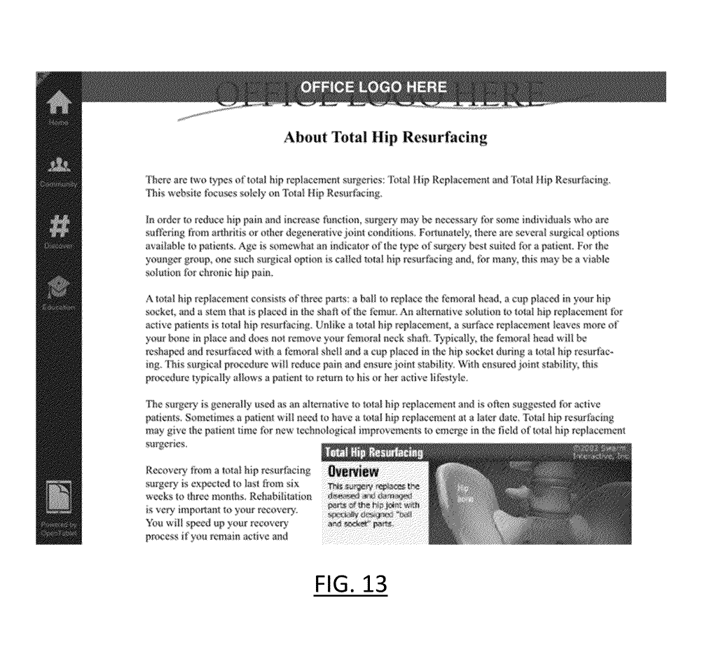

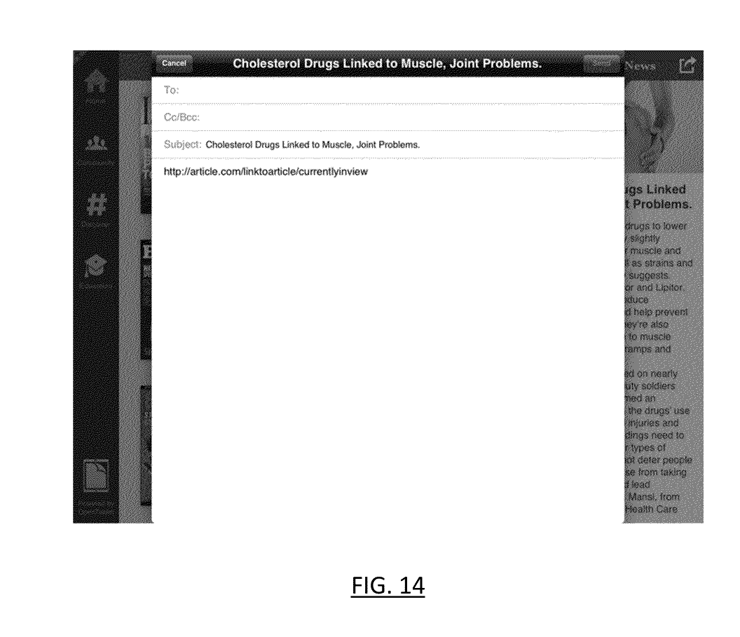

FIG. 9 shows a screen shot of an example environment available in the second mode of the invention. A navigation menu can be provided allowing the user to switch between different content. On a main page, a plurality of digital periodical options and articles providing medical information to the user can be displayed. When a user selects, for example, a particular digital periodical, and as shown in the example of FIG. 10, a full screen browser can be displayed for “thumbing” through the various pages of the periodical. FIG. 11 shows a screen shot of a “community feature” which may be provided within the second mode. In some implementations, the community feature could be configured to browse the medical service provider's social media page(s). In some other implementations, not shown, the community feature could permit patients of the facility to interact via bulletin board, messaging, forums, or chat rooms. It is to be appreciated that in such community features, patients could share healing, health, or dietary tips, and may offer psychological support to others. FIG. 12 shows a screen shot of a “store” feature where a wide variety of products and services can be viewed and purchased by the user. FIG. 13 shows a screen shot of an educational area, where the medical service provider can preselect articles and publications of interest to its patients. In some optional embodiments, and as illustrated in FIG. 14, the second mode can have a “share” feature where an article, product, page, or other information viewed in the second mode can be shared via email, text message, social media, or other means.

As shown in Step 6 of FIG. 2, in the second mode, the software on the mobile computing device may track the patient's entertainment and information choices (e.g., which magazines the patient accesses and how much time a patient accesses an individual page, which websites the patient visits, what informational content the patient accesses, etc.). This information may be collected and may also be saved on the mobile computing device and/or a content server. The data related to the patients' use of the mobile computing device may be compiled by the medical service provider or a system manager to determine which content offered in the second mode is popular and which is unpopular and should be removed. Additionally, the patient may be asked to submit an email address or other personally identifying information to allow the software to track an individual patient's use, thereby allowing the system manager and/or third party advertisers and publishers to tailor content to the individual patient. The user preference data may also have economic value to outside advertising firms and other entities that are interested in using targeting marketing.

In some embodiments, when the patient is ready to be seen by the medical staff, the mobile computing device may be returned to the administrative or medical staff. Optionally, the patient may be allowed to take the mobile computing device with him or her when they are taken to the examination room for continued use of the entertainment and/or informational content in the second mode while they further wait for the medical staff.

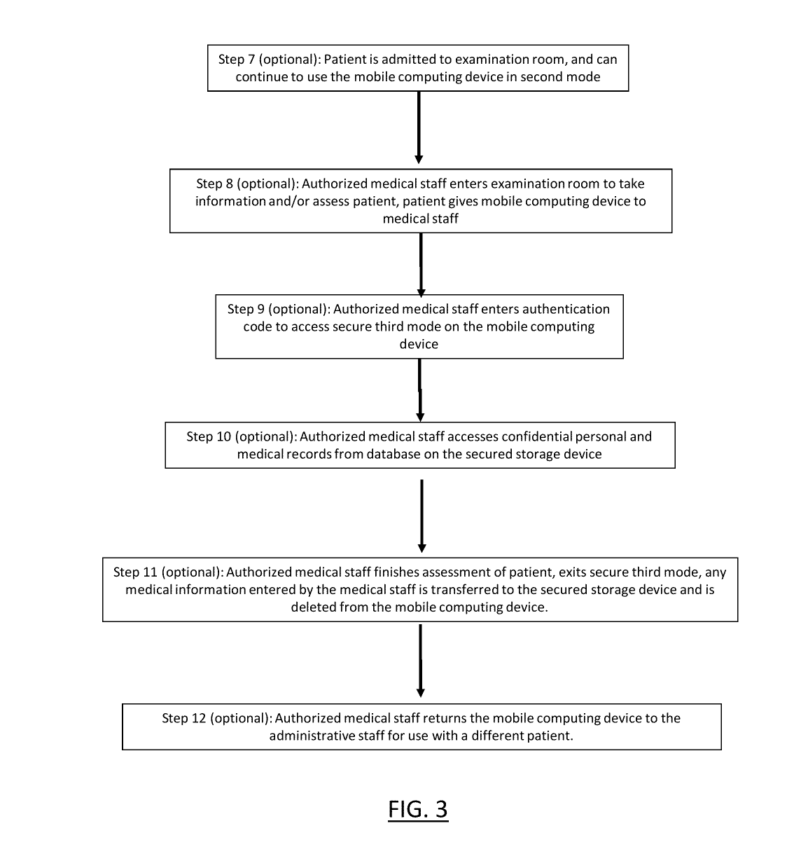

In some embodiments, the system may have a secure third mode for use of the medical staff. FIG. 3 shows a second flow diagram, the steps of which may be included in certain embodiments of the present invention. As shown in Steps 7-10, once the patient is admitted to the examination room, the medical staff can take the mobile computing device from the patient and access a secure third mode by password or other secure access means, and then access the patient's medical records on the secured storage device using the patient's identification number. The confidential information recently entered by the patient in the secure first mode, along with all previously entered information and medical records, may be accessible to the authorized medical staff to allow efficient access to the patient's EMRs and assessment. The authorized medical staff may also enter new EMRs (e.g., diagnoses, vital statistics, notes, prescriptions, etc.) on the secured storage device within the secure third mode. As shown in Step 11 of FIG. 3, following assessment of the patient and/or updating the patient's EMR, the authorized medical staff may complete the secure third mode by activating an exit command, at which point the information entered by the medical staff is securely transmitted to the secured storage device and is erased from the mobile computing device. The mobile computing device may then be returned to the administrative staff and can be prepared for use by another patient (see, e.g., Step 12).

In summary, the present invention provides novel systems and methods for securely collecting confidential user data in a secure first mode and providing entertainment, informational, and/or educational material in a second mode, so as to maintaining the confidentiality of the confidential user data. In some aspects, data reflecting use in the second mode may be gathered and used by a service provider, publisher, advertiser, or marketing company. The system of the present invention may include a mobile computing device having a specializing software platform installed thereon, the platform having a secure first mode for collecting user data and a second mode for providing secondary content. The system may also include a secured storage device for storing confidential personal information (e.g., medical records) and a content server for providing content and/or receiving data regarding user data (e.g., selections of the content by users of the mobile computing devices).

It is to be understood that variations, permutations, and modifications of the present invention may be made without departing from the scope thereof. One or more features of an exemplary embodiment as described above may be practiced in conjunction with one or more features of other exemplary embodiments as described above. It is also to be understood that the present invention is not to be limited by the specific embodiments disclosed herein, but only in accordance with the appended claims. It is further to be appreciated that while reference has been to exemplary systems and methods particularly suited for use in the medical field, the invention is not limited to such uses. Rather, embodiments of the invention can be practiced in connection with other uses which require collection of confidential information prior to provisioning of service to a user by a provider, and which may benefit from providing the user with entertainment, educational, and/or informational content while the user waits for the provider.

What is claimed is:

1. A system for collecting confidential information and providing secondary content comprising:
a) a plurality of mobile computing devices, each device having a software platform comprising (i) a secure first mode adapted to receive said confidential information from a user and (ii) a second mode adapted to provide said secondary content to said user;
b) a secured memory device for receiving said confidential information from each of said mobile computing devices;
c) a content server for providing said secondary content to each of said mobile computing devices; and
d) a wireless communication network, wherein each of said mobile computing devices, said secured memory device, and said content server are engaged with said wireless communication network,
wherein said software platform is adapted to, when said user signals that all confidential information has been entered, transmit said confidential information to said secured memory device, transition said mobile computing device from said secure first mode to said second mode, and delete all confidential information from said mobile computing device.

2. The system of claim 1, wherein said confidential information pertains to the medical field.

3. The system of claim 2, wherein said confidential information is solicited in one or more forms provided on said mobile computing device when said mobile computing device is in said secure first mode.

4. The system of claim 3, wherein said forms are selected from the group consisting of requests for personal identification, requests for contact information, requests for insurance or billing information, office policy disclosures and consents, requests for patient health history, information related to the general health of the patient or specific medical conditions, privacy notices and consents, and combinations thereof.

5. The system of claim 1, wherein said secondary content is selected from the group consisting of educational content, entertainment content, informational content, and combinations thereof.

6. The system of claim 5, wherein said secondary content is selected from the group consisting of digital publications or magazines, a storefront for browsing and purchasing goods or services of others, community sections including social media sites, support sites, frequently asked questions, event and meeting calendars, forums, or chat rooms, news, educational articles, internet browsers, games, and combinations thereof.

7. The system of claim 1, said software platform further comprising (iii) a secure third mode for accessing confidential information from said secured memory device.

8. The system of claim 1, wherein said confidential information pertains to the educational field.

9. The system of claim 8, wherein said confidential information is solicited in one or more examinations provided on said mobile computing device when said mobile computing device is in said secure first mode.

10. The system of claim 1, wherein said second mode of said software platform is further adapted to collect data about the secondary content accessed by said user and transmit said data to one of the group consisting of said content server, a second memory device engaged with said wireless communication network, and combinations thereof.

11. The system of claim 1, wherein said confidential information is solicited in a set of one or more forms in said secure first mode.

12. The system of claim 11, wherein said set is stored on said mobile computing device, said secured memory device, and combinations thereof.

13. A method for receiving confidential information from a user and providing said confidential information to a service provider, comprising the steps of:
a) said service provider selecting a set of one or more forms soliciting said confidential information;
b) said service provider providing a mobile computing device to said user, said mobile computing device having a software platform comprising (i) a secure first mode adapted to provide said set of forms and receive said confidential information from a user and (ii) a second mode adapted to provide said secondary content to said user;
c) said user providing said confidential information by using said mobile computing device in said secure first mode;
d) when said user has completed providing said confidential information, transmitting said confidential information to a secured memory device, transitioning from said secure first mode to said second mode, and deleting all confidential information from said mobile computing device;
e) said service provider retrieving said confidential information from said secured memory device;
f) said user operating said mobile computing device in said second mode to engage with secondary content; and
g) when said user has completed engaging with said secondary content, said user providing said mobile computing device to said service provider.

14. The method of claim 13, said step of selecting said set of forms comprising selecting forms stored on said mobile computing device.

15. The method of claim 14, said step of selecting said set of forms comprising selecting forms stored on said secured memory device and transmitting said set to said mobile computing device

16. The method of claim 13, said forms selected from the group consisting of requests for personal identification, requests for contact information, requests for insurance or billing information, office policy disclosures and consents, requests for patient health history, information related to the general health of the patient and/or specific medical conditions, privacy notices and consents, and combinations thereof.

17. The method of claim 13, said secondary content selected from the group consisting of digital publications or magazines, a storefront for browsing and purchasing goods or services of others, community sections including social media sites, support sites, frequently asked questions, event and meeting calendars, forums, or chat rooms, news, educational articles, internet browsers, games, and combinations thereof.

18. The method of claim 13, said software platform further comprising (iii) a secure third mode for accessing confidential information from said secured memory device, said method further comprising the step of transitioning said mobile computing device from said second mode to said secure third mode.

19. The method of claim 18, said step of transitioning to said secure third mode comprising said service provider entering a password, key code, or other authentication means on said mobile computing device.

20. The method of claim 19, further comprising the step of, in said secure third mode, receiving confidential information from said secured memory device.

21. The system of claim 13, further comprising the step of, in said second mode of said software platform, collecting data about the secondary content accessed by said user and transmitting said data to one of the group consisting of said content server, a second memory device engaged with said wireless communication network, and combinations thereof.

22. A device for electronic collection of confidential information comprising:
a) a secured memory device for receiving said confidential information;
b) a content server for providing secondary content; and
c) a plurality of mobile computing devices, each having a software platform comprising
(i) a secure first mode adapted to
1) present at least one fillable form to a user of the mobile computing device,
2) receive through said at least one fillable form said confidential information from said user,
3) receive an indication from said user that said user has completed providing said confidential information,
4) transmit said confidential information to said secured memory device, and
5) transition said mobile computing device out of said first mode,
(ii) a second mode adapted to
1) receive said secondary content from said content server and present said secondary content to said user,
2) collect use data about said user's interaction with said secondary content, and
3) transmit said use data to said content server.

23. The system of claim 22, said software platform further comprising a secure third mode adapted to receive said confidential information from said secured memory device.

24. The system of claim 22, said first mode further adapted to delete said confidential information from said mobile computing device.
